(19) United States
(12) Patent Application Publication
(10) Pub. No.: US 2006/0005866 A1
(43) Pub. Date: Jan. 12, 2006

(54) Apparatus for cleaning latex paint rollers

(76) Inventor: L. Jay McCreary, Slidell, LA (US)

Correspondence Address: L. Jay McCreary, 130 Middlebrook Drive, Slidell, LA, 70458, US

(21) Appl. No.: 10/885,394

(22) Filed: Jul. 6, 2004

(51) Int. Cl. B08B 3/04

(52) U.S. Cl. 134/166 R; 134/152; 134/169 R; 134/900

(57) ABSTRACT

An apparatus for cleaning latex paint rollers with A pressure molded bucket-like round container, 12 inches tall, fully open at the bottom which is 10 inches in diameter, A 3 inch aperture, offset 1 inch from the side in the 6 inch diameter solid top. The latex paint roller on it's handle is inserted downward into the container, suspended and freely able to spin, and Container has a side opening, 1½ inches wide and 10 inches long, extending vertically from top to bottom with a 1 inch gap of solid plastic at each end of the side opening for stability. The side aperture allows the user to insert a garden hose on full flow to be inserted into the container and direct water onto the suspended latex paint roller, spinning the roller and thereby removing the latex paint by the fast spinning of the roller and the water.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field painting and more specifically to an apparatus for cleaning latex paint rollers.

Any person who house paints, either the home owner or the professional painter, knows how difficult it is to effectively clean a latex paint roller. Either the latex paint roller is cleaned in the roller pan, which is time consuming and messy, or it is sprayed or rinsed with a garden hose which is messy as well.

The paint blaster uses the forces of nature, centrifugal force created by the garden hose water stream to rapidly spin the paint roller throwing off the latex paint as the water separates the paint from the roller. It is a simple, not labor intensive, method to remove the latex paint and the roller comes out virtually dry, ready for the next painting job. This application has not been utilized in the past Sherwin Williams paint company sells a push-pull handle devise that slowly turns the paint roller attached to the end of the push-pull handle. The devise is expensive and very labor intensive. There are no other devises to accomplish what the proposed paint blaster does. By using the forces of nature, centrifugal force from the garden hose stream spinning the paint roller quickly within the container, the latex paint separates from the roller in seconds and comes out free of latex paint and virtually dry for the next painting task.

### BRIEF SUMMARY OF THE INVENTION

The primary object of the invention is Inexpensive to manufacture.

Another object of the invention is Simple design with no moving parts within the apparatus.

Another object of the invention is One piece integral design of the apparatus.

A further object of the invention is Easy to store and inventory.

Yet another object of the invention is Uses natural forces, water and centrifugal force, to operate the apparatus.

Still yet another object of the invention is Easy to maintain.

Another object of the invention is Operates cleanly.

Another object of the invention is Eliminates messy latex paint roller cleanup.

A further object of the invention is Long useful operational apparatus life.

Yet another object of the invention is Cleans latex paint rollers quickly.

Still yet another object of the invention is Cleans latex paint rollers thoroughly.

Another object of the invention is Cleans latex paint rollers with no paint spatters to user.

Another object of the invention is Saves expense by re-using latex paint rollers.

A further object of the invention is Saves waiting time between coats because cleaned latex paint roller can be re-used quickly.

Yet another object of the invention is The thoroughly cleaned latex paint rollers allows painter to quickly change latex paint color and continue.

Still yet another object of the invention is The apparatus cleans different sizes of latex paint rollers.

Another object of the invention is The apparatus cleans latex paint rollers of different thickness.

Another object of the invention is The apparatus is easy to operate.

A further object of the invention is The apparatus is sturdy.

Yet another object of the invention is Using the apparatus is safe to the environment.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for cleaning latex paint rollers comprising: A pressure molded bucket-like round container, 12 inches tall, fully open at the bottom which is 10 inches in diameter, A 3 inch aperture, offset 1 inch from the side in the 6 inch diameter solid top. The latex paint roller on it's handle is inserted downward into the container, suspended and freely able to spin, and Container has a side opening, 1½ inches wide and 10 inches long, extending vertically from top to bottom with a 1 inch gap of solid plastic at each end of the side opening for stability. The side aperture allows the user to insert a garden hose on full flow to be inserted into the container and direct water onto the suspended latex paint roller, spinning the roller and thereby removing the latex paint by the fast spinning of the roller and the water.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

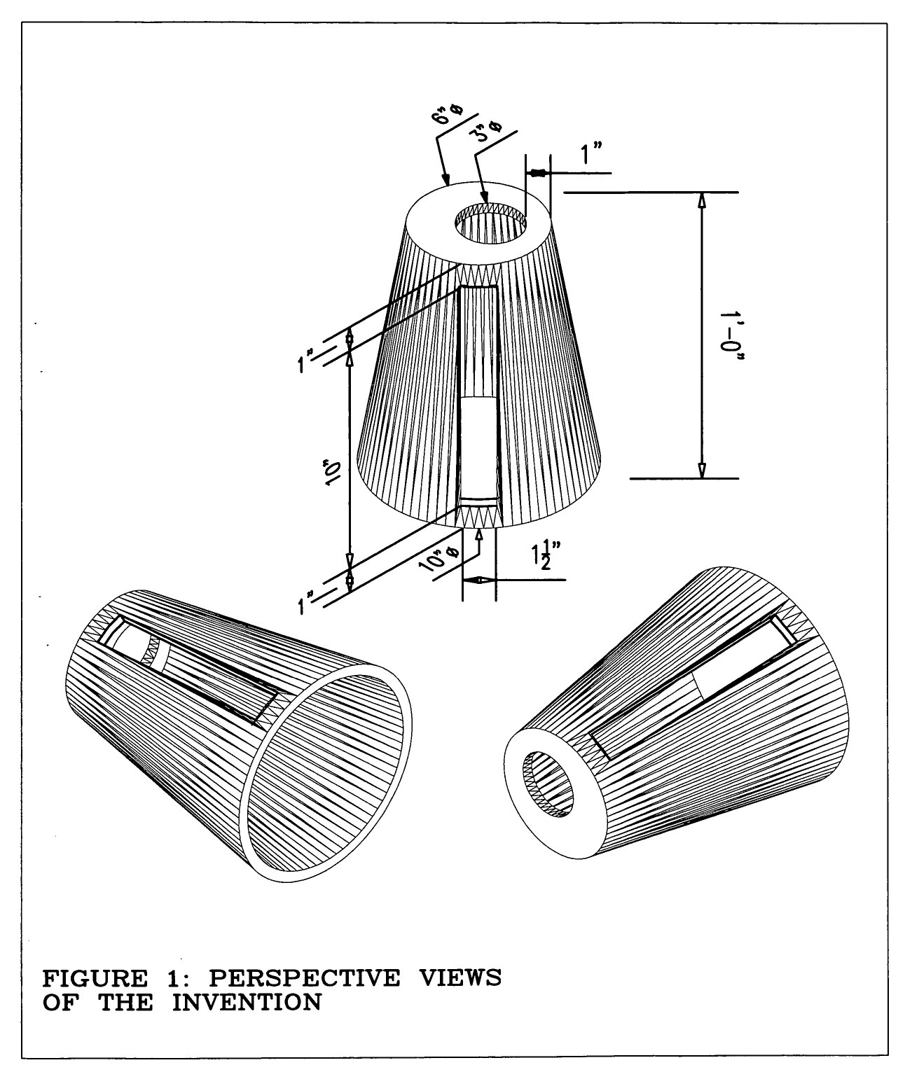

Turning to FIG. 1. there is shown a bucket-like container, twelve (12) inches tall, with an open bottom (B), ten (10) inches in diameter. The container has a solid top (T) six (6) inches in diameter, which has a three (3) inch diameter aperture, offset one (1) inch from the side of the top. The apparatus also incorporates a vertical opening (S) down the side of the container, one and one half (1 and ½) inches wide and ten (10) inches long with a one (1) inch gap of solid plastic at both the top and bottom of the side opening for stability.

The invention operates by the user, following a latex painting job, inserting the latex paint roller, still on it's handle, into the three inch opening in the top of the container. The latex paint roller is suspended inside the container and spins freely on it's handle. The side opening allows the user to insert a garden hose nozzle on full flow into the container and direct the water flow onto the suspended latex paint roller. In operation, the full force stream of water from the inserted garden hose quickly spins the suspended latex paint roller. The paint roller is held in place in the middle interior of the container by the still attached paint roller handle. The combined effect of the quickly spinning roller coupled with the natural cleaning property of the sprayed water being a natural solvent of latex paint cause the latex paint to separate from the roller and spin off of the roller in a matter of seconds. The user can clean completely the entire length of the suspended latex paint roller by sliding the garden hose nozzle from top to bottom of the apparatus side opening thereby directing the water flow directly over the entire length of the paint roller.

The spinning of the suspended latex paint roller, coupled with the separating effect of the water, throws the latex paint off of the roller. The water and latex paint mixture strikes the inside wall of the container and falls out of the open bottom of the container.

The invention will also operate effectively if the container material is metal rather than molded plastic. Different dimensions of the container and/or dimensions of the apertures may also be incorporated.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for cleaning latex paint rollers comprising:
A pressure molded bucket-like round container, 12 inches tall, fully open at the bottom which is 10 inches in diameter;
A 3 inch aperture, offset 1 inch from the side in the 6 inch diameter solid top. The latex paint roller on it's handle is inserted downward into the container, suspended and freely able to spin; and
Container has a side opening, 1½ inches wide and 10 inches long, extending vertically from top to bottom with a 1 inch gap of solid plastic at each end of the side opening for stability. The side aperture allows the user to insert a garden hose on full flow to be inserted into the container and direct water onto the suspended latex paint roller, spinning the roller and thereby removing the latex paint by the fast spinning of the roller and the water.

2. An apparatus for cleaning latex paint rollers as claimed in claim 1 further comprising
A square container instead of a round container

3. An apparatus for cleaning latex paint rollers as claimed in claim 1 further comprising
Different dimensions of openings in the apparatus

4. An apparatus for cleaning latex paint rollers as claimed in claim 1 further comprising
A container made of metal

5. An apparatus for cleaning latex paint rollers as claimed in claim 1 further comprising
A container of different dimensions

6. An apparatus for cleaning latex paint rollers as claimed in claim 1 further comprising
A container using slits in the container top and side openings as the openings in the container

7. An apparatus for cleaning latex paint rollers as claimed in claim 1 further comprising
A container using a different length of side opening

8. An apparatus for cleaning latex paint rollers as claimed in claim 1 further comprising
A container using a different offset of the top aperture

9. An apparatus for cleaning latex paint rollers as claimed in claim 2 further comprising
A container of different dimensions

10. An apparatus for cleaning latex paint rollers as claimed in claim 2 further comprising
A container using different dimensions of side and top openings
